(19) United States
(12) Patent Application Publication
(10) Pub. No.: US 2009/0029714 A1
(43) Pub. Date: Jan. 29, 2009

(54) METHOD OF ALLOCATING BANDWIDTH FOR TRANSMISSION OF CHANNEL QUALITY INFORMATION

(76) Inventor: Ashok N. Rudrapatna, Basking Ridge, NJ (US)

Correspondence Address: Mark W. Sincell, Ph.D.;Williams, Morgan & Amerson, P.C., Suite 1100, 10333 Richmond, Houston, TX, 77042, US

(21) Appl. No.: 11/782,669

(22) Filed: Jul. 25, 2007

(51) Int. Cl. H04Q 7/20

(52) U.S. Cl. 455/452.2

(57) ABSTRACT

The present invention provides a method of allocating bandwidth for transmission of channel quality information. The method includes reducing a bandwidth allocated to transmission of channel quality information over an air interface in a first direction in response to determining that traffic over the air interface in the first direction has increased.

### BACKGROUND OF THE INVENTION

1. Field of the Invention

This invention relates generally to communication systems, and, more particularly, to wireless communication systems.

2. Description of the Related Art

Each base station in a conventional wireless communication system is typically responsible for providing wireless connectivity to numerous mobile units over an air interface that includes several downlink (or forward link) and uplink (or reverse link) channels. The quality of the various channels typically fluctuates due to changes in the relative position of the mobile units and the base station and changes in the environmental conditions between the mobile units and the base station, such as due to fast fading. The channel quality fluctuations also lead to fluctuations in the throughput of the channels. For example, the throughput from a mobile unit to a base station typically decreases when the channel quality of the corresponding uplink channel declines. However, the channel quality fluctuations associated with different channels are usually uncorrelated. Consequently, a channel utilization and throughput can be improved by preferentially scheduling transmissions on channels that have relatively high channel qualities.

State-of-the-art Third Generation (3G) and Forth Generation (4G) wireless communication systems use channel state feedback to estimate channel qualities and schedule transmission on uplink and downlink channels when conditions are favorable. Scheduling transmissions may include allocating time, channels, power, data rates, and other resources for the transmission. For example, mobile units may estimate the downlink channel quality using a pilot signal provided by the base station. The mobile unit may then transmit channel state feedback, such as a Channel Quality Indicator (CQI), back to the base station, which can then use this feedback to schedule transmission on the downlink. In some cases, one or more channels may be reserved for transmitting a channel state feedback between the mobile units and the base station. For example, in the Evolved, Data-Optimized (EVDO) systems, a data rate control (DRC) channel is used to transmit Channel Quality Indicators.

The channel state feedback for the uplink and downlink channels is provided substantially continuously so that the base stations and the mobile units always have access to up-to-date channel quality information. However, providing channel state feedback is relatively expensive. For example, transmitting the Channel Quality Indicators over the DRC channels consumes significant bandwidth. The amount of bandwidth utilized to transmit the channel state feedback may be a function of the data resolution (e.g., two bits, four bits, or more) and the frequency of the feedback. Some systems (e.g., WIMAX, UMB, and LTE) also provide feedback for multiple sub-bands of the uplink and/or downlink channels, which further increases the bandwidth overhead associated with providing the channel state feedback. Furthermore, systems that include multiple antennas, such as multiple-input-multiple-output (MIMO) communication systems may require more complex channel state feedback that indicates preferred antenna, amplitude and phase information for one or more antennas, etc. The bandwidth overhead associated with these systems may be correspondingly increased to transmit this information.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for allocating bandwidth for transmission of channel quality information. The method includes reducing a bandwidth allocated to transmission of channel quality information over an air interface in a first direction in response to determining that traffic over the air interface in the first direction has increased.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates a first exemplary embodiment of a method of allocating bandwidth for transmission of channel quality information, in accordance with the present invention; and

FIG. 3 conceptually illustrates a second exemplary embodiment of a method of allocating bandwidth for transmission of channel quality information, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

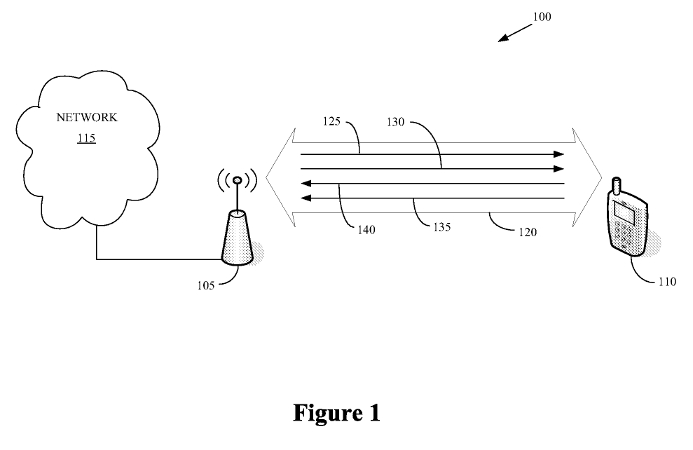

FIG. 1 conceptually illustrates one exemplary embodiment of a wireless communication system 100. In the illustrated embodiment, the wireless communication system 100 includes one or more base stations 105 for providing wireless connectivity to one or more mobile units 110. In the interest of clarity, only one base station 105 and one mobile unit 110 are depicted in FIG. 1. However, persons of ordinary skill in the art having benefit of the present disclosure should appreciate that the present invention is not limited to wireless communication systems 100 that include a single base station 105 and the single mobile unit 110. In alternative embodiments, the wireless communication system 100 may include any number of base stations 105 and/or mobile units 110. Furthermore, alternative embodiments of the wireless communication system 100 may use devices other than the base stations 105 to provide wireless connectivity. For example, the wireless communication system 100 may include one or more base station routers, access networks, access serving networks, access points, and the like.

The mobile unit 110 may communicate with a network 115 via an air interface 120 between the base station 105 and the mobile unit 110. The air interface 120 may be established and/or operated according to any wireless communication standard and/or protocol. Exemplary wireless communication standards and/or protocols include, but are not limited to, the standards and/or protocols defined by the Third Generation Partnership Project (3GPP, 3GPP2), Universal Mobile Telecommunication System (UMTS) standards and/or protocols, Evolved, Data-Optimized (EVDO) standards and/or protocols, High Speed Uplink or Downlink Packet Access (HSUPA, HSDPA) standards and/or protocols, Long Term Evolution (UMTS-LTE) standards and/or protocols, Global System for Mobile communication (GSM) standards and/or protocols, WiMAX standards and/or protocols, IEEE standards and/or protocols, and the like. Techniques for establishing and/or operating the air interface 120 are known in the art and in the interest of clarity only those aspects of establishing and/or operating the air interface 120 and that are relevant to the present invention will be discussed herein.

The air interface 120 supports various uplink and/or downlink channels. In the illustrated embodiment, the interface 120 supports one or more downlink traffic channels 125, one or more signaling channels 130 for transmitting downlink channel quality information, one or more uplink traffic channels 135, and one or more signaling channels 140 for transmitting uplink channel quality information. For example, the traffic channels 125, 130 may be data channels (DCH) and the signaling channels 130, 140 may be data rate control (DRC) channels. However, persons of ordinary skill in the art having benefit of the present disclosure should appreciate that the air interface 120 may also support other uplink and/or downlink channels that are not depicted in FIG. 1, such as broadcast channels, paging channels, random access channels, and the like. The channels 125, 130, 135, 140 may be defined in accordance with the standards and/or protocols used to implement the air interface 120. These channels could also be used for proprietary or semi-proprietary air interfaces. In various alternative embodiments, the channels 125, 130, 135, 140 may be defined in terms of time slots, frequencies, coding sequences, orthogonal frequencies, or any combination thereof.

In operation, the base station 105 may transmit voice or data information to the mobile unit 110 over the downlink traffic channel 125. The base station 105 may also transmit channel quality information to the mobile unit over the downlink signaling channel 130. The channel quality information transmitted by the base station 105 may include information that indicates an estimate of the quality of the uplink channels 135, 140, such as an estimate of the channel quality determined using signals provided by the mobile unit 110. The mobile unit 110 may transmit voice or data information to the base station 105 over the uplink traffic channel 135. The transmissions over the uplink traffic channel 135 may be scheduled using the channel quality information received from the base station 105. The mobile unit 110 may also transmit channel quality information to the base station 105 over the uplink signaling channel 140. The channel quality information transmitted by the mobile unit 105 may include information that indicates an estimate of the quality of the downlink channels 125, 130, such as an estimate of the channel quality that is determined using pilot, preamble, or similar signals provided by the base station 105. The base station 105 may use the provided channel quality information to schedule voice or data information for transmission over the downlink traffic channel 125.

The base station 105 and/or the mobile unit 110 may allocate bandwidth for transmission of the channel quality information based upon the amount of traffic being transmitted over the traffic channels 125, 135. In one embodiment, the bandwidth allocated for transmission of the channel quality information in one direction may be reduced in response to determining that traffic being transmitted in that direction has increased. For example, if the base station 105 begins transmitting voice information to the mobile unit 110 over the traffic channel 125, it is likely that the mobile unit 110 will be “listening” and not transmitting data over the traffic channel 135. Consequently, the base station 105 may reduce the bandwidth allocated for transmitting channel quality information over the signaling channel 130. Reducing the bandwidth in this manner may reduce the overhead associated with transmitting the channel quality information but may have very little effect on the performance of the traffic channel 135, since the traffic channel 135 is likely to be idle while the voice information is being transmitted over the traffic channel 125. The mobile unit 110 may also reduce the bandwidth allocated to transmitting channel quality information over the signaling channel 140 when it is transmitting information to the base station 105 over the traffic channel 135.

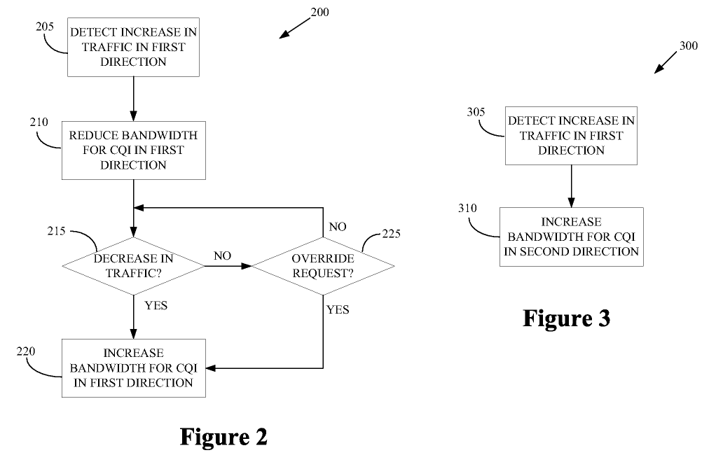

FIG. 2 conceptually illustrates a first exemplary embodiment of a method 200 of allocating bandwidth for transmission of channel quality information in a first direction. The method 200 may be implemented in a base station, such as the base station 105 shown in FIG. 1, and/or a mobile unit, such as the mobile unit 110 shown in FIG. 1. When the method 200 is implemented in the base station, the first direction corresponds to the downlink from the base station to one or more mobile units and a second direction opposite to the first direction corresponds to the uplink. When the method 200 is implemented in the mobile unit, the first direction corresponds to the uplink from the mobile unit to the base station and the second direction corresponds to the downlink. In the illustrated embodiment, traffic in the first direction is detected (at 205). For example, a Voice over Internet Protocol (VoIP) or circuit switched application implemented in a base station or mobile unit may generate data traffic to be transmitted over a traffic channel in the first direction.

In response to detecting (at 205) the increase in traffic transmitted in the first direction, the bandwidth allocated for transmission of channel quality information over a signaling channel in the first direction may be reduced (at 210). For example, the VoIP application that generated the data being transmitted over the traffic channel in the first direction may provide signaling to inform a baseband processor in the base station or the mobile unit to reduce (at 210) the bandwidth allocated for transmission of channel quality information over the signaling channel in the first direction. The bandwidth allocation may be reduced (at 210) by reducing (at 210) the data resolution used to transmit the channel quality information or by reducing (at 210) the frequency at which the channel quality information is transmitted over the signaling channel in the first direction. In one embodiment, the bandwidth allocation may be reduced (at 210) to zero so that transmission of the channel quality information over the signaling channel in the first direction is interrupted.

The traffic may be monitored to determine (at 215) whether the traffic in the first direction decreases. A decrease in the traffic in the first direction may indicate an increase (or an upcoming or expected increase) in traffic in the second direction opposite to the first direction. For example, a decrease in the uplink traffic may indicate an upcoming increase in downlink traffic transmitted in response to the uplink traffic. If a decrease in the traffic in the first direction is detected (at 215), the bandwidth for channel quality information transmitted in the first direction may be increased (at 220). Increasing (at 220) the bandwidth for channel quality information transmitted in the first direction may permit more and/or higher resolution and/or more frequent channel quality information to be transmitted and used to improve scheduling of traffic in the second direction.

Override requests may also be provided to indicate that the bandwidth reduction for channel quality information in the first direction should be overridden so that the allocated bandwidth is increased and/or returned to its original level. For example, an override request may be transmitted in the second direction to request additional channel quality information so that current or upcoming traffic in the second direction may be scheduled. This override may also be triggered by increase of traffic in the second direction. Accordingly, if an override request is detected (at 225), then the bandwidth for transmission of channel quality information in the first direction may be increased (at 220. If no override request is detected (at 225) and no decrease in traffic in the first direction is detected (at 215), then the reduced bandwidth allocation may be maintained.

FIG. 3 conceptually illustrates a second exemplary embodiment of a method 300 of allocating bandwidth for transmission of channel quality information. As discussed above, the method 300 may be implemented in a base station, such as the base station 105 shown in FIG. 1, and/or a mobile unit, such as the mobile unit 110 shown in FIG. 1. In the illustrated embodiment, an increase in traffic in the first direction is detected (at 305) by the entity that is receiving the traffic. For example, a mobile unit may detect (at 305) an increase in downlink traffic provided by a base station. The increase in traffic may indicate that a burst of voice and/or data information has begun. Scheduling of the voice and/or data information may be improved using additional channel quality information. Accordingly, the bandwidth allocated for channel quality information transmitted in the second direction, opposite to the first direction, may be increased (at 310).

Embodiments of the techniques described herein may have a number of advantages over conventional practice. For example, allocating bandwidth for channel quality information based upon the traffic so that channel quality information is only transmitted when it is needed to schedule the traffic may reduce the overhead associated with transmitting channel quality information without impacting the scheduling algorithms. Accordingly, scarce bandwidth resources may be preserved and the efficiency of the wireless communication system may be maintained. The bandwidth savings may be particularly significant in systems that provide multiple channel quality indicators associated with different sub-bands and/or different antennas.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed is:

1. A method, comprising:
reducing a bandwidth allocated to transmission of channel quality information over an air interface in a first direction in response to determining that traffic over the air interface in the first direction has increased.

2. The method of claim 1, wherein reducing the bandwidth comprises reducing the bandwidth allocated to transmission of channel quality information over an uplink supported by the air interface in response to determining that traffic over the uplink has increased.

3. The method of claim 1, wherein reducing the bandwidth comprises reducing the bandwidth allocated to transmission of channel quality information over a downlink supported by the air interface in response to determining that traffic over the downlink has increased.

4. The method of claim 1, wherein reducing the bandwidth comprises reducing at least one of a data resolution and a transmission frequency associated with transmission of the channel quality information.

4. The method of claim 1, comprising determining that traffic over the air interface in the first direction has increased.

5. The method of claim 4, wherein determining that traffic over the air interface in the first direction has increased comprises detecting, at a transmitting entity, an increase in traffic to be transmitted over the air interface in the first direction by the transmitting entity.

6. The method of claim 1, comprising increasing the bandwidth substantially after reducing the bandwidth allocated to transmission of the channel quality information over the air interface in the first direction.

7. The method of claim 6, wherein increasing the bandwidth comprises increasing the bandwidth in response to receiving, at an entity transmitting traffic in the first direction, a signal from an entity that receives the traffic transmitted in the first direction, the signal requesting an increase in the bandwidth allocated to transmission of the channel quality information over the air interface in the first direction.

8. The method of claim 6, wherein increasing the bandwidth comprises increasing the bandwidth in response to determining that traffic transmitted in the first direction has decreased.

9. The method of claim 6, wherein increasing the bandwidth comprises increasing the bandwidth in response to determining that traffic transmitted in the second direction has increased.
